(19) United States
(12) Patent Application Publication
(10) Pub. No.: US 2025/0376077 A1
(43) Pub. Date: Dec. 11, 2025

(54) METHOD FOR CONTROLLING A BATTERY FOR A VEHICLE AND A CONTROLLER IMPLEMENTING THE SAME

(71) Applicants: HYUNDAI MOTOR COMPANY, Seoul (KR); KIA CORPORATION, Seoul (KR)

(72) Inventor: Won Jae Lee, Hwaseong-si (KR)

(73) Assignees: HYUNDAI MOTOR COMPANY, Seoul (KR); KIA CORPORATION, Seoul (KR)

(21) Appl. No.: 18/954,066

(22) Filed: Nov. 20, 2024

(30) Foreign Application Priority Data
Jun. 5, 2024 (KR) 10-2024-0073667

(51) Int. Cl. B60L 58/22; B60L 58/12

(52) U.S. Cl. CPC B60L 58/22; B60L 58/12; B60L 2240/421; B60L 2250/18

(57) ABSTRACT

A method of controlling a battery of a vehicle is provided. The vehicle includes a driving motor for providing a driving force to a wheel. The method includes selecting, by a controller, a battery among a first battery and a second battery based on a plurality of driving areas and operation points for the driving motor. The method also includes controlling, by the controller, the use of the selected battery to supply power to the driving motor of the vehicle. Selecting the battery includes classifying the plurality of driving areas according to a reference power.

### CROSS-REFERENCE TO RELATED APPLICATIONS

The present application claims the benefit of and priority to Korean Patent Application No. 10-2024-0073667, filed on Jun. 5, 2024, the entire contents of which are hereby incorporated herein by reference.

### TECHNICAL FIELD

The present disclosure relates to a method of controlling a battery of a vehicle, a controller therefor, and the vehicle.

### BACKGROUND

The statements in this section merely provide background information related to the present disclosure and may not constitute prior art.

Generally, an electric vehicle, a type of a mobility apparatus, is operated with wheels driven by a driving force of a driving motor.

It is common for a high voltage battery to be fixed to and mounted on the vehicle to supply power to the driving motor.

The driving motor may be an alternating current (AC) motor and an inverter may be arranged between the battery and the driving motor.

When the battery of an electric vehicle requires charging according to its state of charge (SOC), it is charged by receiving external power through an on-board charger (OBC).

The time required for charging an electric vehicle is determined by the charging method. There are two main types of charging: slow charging and fast charging.

By virtue of continuous research and development on batteries, in recent days, driving range per charge has been significantly improved.

However, a single battery may still be insufficient.

The information included in this Background section is merely to enhance understanding of the general background of the present disclosure. Therefore, the Background section should not be taken as an acknowledgement or any form of suggestion that this information forms the prior art already known to a person having ordinary skill in the art to which the present disclosure pertains.

### SUMMARY

The present disclosure was made to solve the above-described problems occurring in the prior art while advantages achieved by the prior art are maintained intact.

An embodiment of the present disclosure provides a strategy for efficiently operating a dual battery by taking into account an operation point of a driving motor.

Embodiments of the present disclosure provide a new concept of using a second high voltage battery that can be attached to and detached from a power system of an electric vehicle as needed in addition to a first high voltage battery that has been already installed in the electric vehicle.

According to an embodiment of the present disclosure, a method of controlling batteries for a vehicle is provided. The vehicle includes a driving motor for providing a driving force to a wheel of the vehicle. The method includes selecting, by a controller, a battery among a first battery and a second battery based on a plurality of driving areas and an operation point for the driving motor. The method also includes controlling, by the controller, usage of the selected battery to supply power to the driving motor or receive power regenerated by the driving motor. Selecting the battery includes classifying the plurality of driving areas according to a reference power.

In at least one embodiment of the present disclosure, classifying the plurality of driving areas may include classifying the plurality of driving areas according to an equal power reference line of the reference power based on a torque-RPM map of the driving motor.

In at least one embodiment of the present disclosure, classifying the plurality of driving areas may further include determining the reference power based on usage levels of the first and second batteries based on the charge levels thereof.

In at least one embodiment of the present disclosure, determining the reference power may include determining the reference power based on an expected driving route and the usage levels.

In at least one embodiment of the present disclosure, determining the reference power based on the expected driving route and the usage level may include determining one or more sections of the expected driving route based on driving situations, determining an expected power of each of the one or more sections, determining an average power and a standard deviation for the expected driving route, and determining the reference power based on the usage levels using the average power and the standard deviation.

In at least one embodiment of the present disclosure, determining the reference power based on the usage levels using the average power and the standard deviation may include determining a target usage level value based on a charge ratio of the first battery and a charge ratio of the second battery.

In at least one embodiment of the present disclosure, determining the reference power based on the usage levels using the average power and the standard deviation may further include determining a Z-score from a standard normal distribution table based on the target usage level value to determine a reference parameter and determining the reference power based on the average power, the standard deviation, and the reference parameter.

In at least one embodiment of the present disclosure, the first battery may have a higher voltage than the second battery, and determining the reference power based on the average power, the standard deviation, and the reference parameter may include at least one of determining the reference power for discharge by subtracting the product of the reference parameter and the standard deviation from the average power when the charge ratio of the first battery is greater than the charge ratio of the second battery, determining the reference power for the discharge by adding the product of the reference parameter and the standard deviation to the average power when the charge ratio of the first battery is less than the charge ratio of the second battery, determining the reference power for charging by adding the product of the reference parameter and the standard deviation to the average power when the charge ratio of the first battery is greater than the charge ratio of the second battery, or determining the reference power for the charging by subtracting the product of the reference parameter and the standard deviation from the average power when the charge ratio of the first battery is less than the charge ratio of the second battery.

In at least one embodiment of the present disclosure, determining the average power and the standard deviation may include determining a driving ratio of each of the one or more sections for the entire expected driving route and determining the average power and the standard deviation based on the expected power and the driving ratio of each of the one or more sections.

In at least one embodiment of the present disclosure, determining the expected power of each of the one or more sections may include determining the expected power based on data on driving habits of a driver of the vehicle.

According to another embodiment of the present disclosure, a vehicle controller configured to control batteries for a vehicle is provided. The vehicle includes a driving motor for providing a driving force to a wheel of the vehicle. The vehicle controller includes a non-transitory memory storing instructions and one or more processors configured to execute the instructions. The instructions, when executed by the one or more processors, cause the one or more processors to select a battery among a first battery and a second battery based on a plurality of driving areas and an operation point for the driving motor. The instructions, when executed by the one or more processors, also cause the one or more processors to control usage of the selected battery to supply power to the driving motor or receive power regenerated by the driving motor. The one or more processors are configured to select the battery based on classifying the plurality of driving areas according to a reference power.

In at least one embodiment of the present disclosure, the instructions, when executed by the one or more processors, cause the one or more processors to classify the plurality of driving areas according to an equal power reference line of the reference power based on a torque-RPM map of the driving motor.

In at least one embodiment of the present disclosure, the instructions, when executed by the one or more processors, cause the one or more processors to determine the reference power based on usage levels of the first and second batteries based on the charge levels thereof.

In at least one embodiment of the present disclosure, the instructions, when executed by the one or more processors, cause the one or more processors to determine the reference power based on an expected driving route and the usage levels.

In at least one embodiment of the present disclosure, the instructions, when executed by the one or more processors, cause the one or more processors to determine one or more sections of the expected driving route based on driving situations, determining an expected power of each of the one or more sections, determine an average power and a standard deviation for the expected driving route, and determine the reference power based on the usage levels using the average power and the standard deviation.

In at least one embodiment of the present disclosure, the instructions, when executed by the one or more processors, cause the one or more processors to determine a target usage level value based on a charge ratio of the first battery and a charge ratio of the second battery.

In at least one embodiment of the present disclosure, the instructions, when executed by the one or more processors, cause the one or more processors to determine a Z-score from a standard normal distribution table based on the target usage level value to determine a reference parameter, and determine the reference power based on the average power, the standard deviation, and the reference parameter.

In at least one embodiment of the present disclosure, the first battery may have a higher voltage than the second battery, and the instructions, when executed by the one or more processors, cause the one or more processors to perform at least one: of determine the reference power for discharge by subtracting the product of the reference parameter and the standard deviation from the average power when the charge ratio of the first battery is greater than the charge ratio of the second battery; determine the reference power for the discharge by adding the product of the reference parameter and the standard deviation to the average power when the charge ratio of the first battery is less than the charge ratio of the second battery; determine the reference power for charging by adding the product of the reference parameter and the standard deviation to the average power when the charge ratio of the first battery is greater than the charge ratio of the second battery; or determine the reference power for the charging by subtracting the product of the reference parameter and the standard deviation from the average power when the charge ratio of the first battery is less than the charge ratio of the second battery.

In at least one embodiment of the present disclosure, the instructions, when executed by the one or more processors, cause the one or more processors to determine a driving ratio of each of the one or more sections for the entire expected driving route and determining the average power and the standard deviation based on the expected power and the driving ratio of each of the one or more sections.

In at least one embodiment of the present disclosure, the instructions, when executed by the one or more processors, cause the one or more processors to determine the expected power based on data on driving habits of a driver of the vehicle.

According to embodiments of the present disclosure, it may be possible to improve energy efficiency through a strategy for efficiently using a dual battery based on an operation point of a driving motor.

In addition, according to an embodiment of the present disclosure, it may be possible to reduce power loss and increase system efficiency by distinguishing the areas in which each of two batteries is used based on voltage, aiming at minimizing the amount of used current.

According to an embodiment of the present disclosure, it may be possible to extend a driving range of an electric vehicle and improve its usability by removably connecting the second high voltage battery to the electric vehicle's power system.

According to an embodiment of the present disclosure, it may be possible to reduce power loss, increase system efficiency, and extend the life of batteries by distinguishing the areas in which each of two batteries is used based on a driver's driving habits learned for each driving situation, aiming at minimizing the amount of used current, and selecting and using one of the two batteries based on the areas.

According to an embodiment of the present disclosure, a power reference line for determining a battery to be used may vary depending on a driver's driving habits or driving power, driving conditions, and batteries' specifications or capacity, so that the strategy for operating batteries may be optimized, the biased use of the batteries may be prevented, which prevents the deterioration of the batteries' durability, and a frequent switch from one battery to another one may be prevented.

The methods and apparatuses of the present disclosure have other features and advantages which should be more apparent from, or are set forth in more detail in, the detailed description below and the accompanying drawings, which together serve to explain certain principles of the present disclosure.

### BRIEF DESCRIPTION OF THE DRAWINGS

FIG. 1 shows a power system of a first mobility apparatus according to an embodiment of the present disclosure.

FIG. 2 shows a second mobility apparatus connected to the first mobility apparatus according to an embodiment of the present disclosure.

FIG. 3 illustrates a control process according to an embodiment of the present disclosure.

FIG. 4 shows an example of specifications of a first high voltage battery and a second high voltage battery according to an embodiment of the present disclosure.

FIG. 5 shows an example of multiple driving areas on a torque-RPM map according to an embodiment of the present disclosure.

FIG. 6 illustrates a control simulation according to an embodiment of the present disclosure.

FIG. 7 illustrates the process of determining a power reference line for determining a battery to be used according to an embodiment of the present disclosure.

FIG. 8 shows an example of data on driving habits for each driving situation according to an embodiment of the present disclosure.

FIG. 9 shows a standard normal distribution table according to an embodiment of the present disclosure.

FIG. 10 shows the result of applying one embodiment of the present disclosure to a virtual expected driving route.

FIG. 11 shows equal power reference lines based on reference powers for each course in FIG. 10 according to an embodiment of the present disclosure.

It should be understood that the accompanying drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments are described in detail below with reference to the accompanying drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components have been physically or chemically separated or can be so separated.

Terms containing ordinal numbers such as “first” and “second” may be used to describe various components, but the components are not limited by the terms. The above-mentioned terms are used only as names to distinguish one component from another component, and the order therebetween may be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

When a component, device, element, or the like of the present disclosure is described as having a purpose or performing an operation, function, or the like, the component, device, or element should be considered herein as being “configured to” meet that purpose or perform that operation or function.

The terms used herein are only used to describe specific embodiments and are not intended to limit the present disclosure. Expressions in the singular form include the meaning of the plural form unless they clearly mean otherwise in the context. In the present disclosure, expressions such as “include,” “comprise,” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the art to which the present disclosure pertains. Terms defined in commonly used dictionaries should be interpreted as having meanings consistent with the meanings they have in the context of the relevant technology, and should not be interpreted in an ideal or overly formal sense unless explicitly defined in the present disclosure.

In addition, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

The processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, embodiments of the present disclosure are described in detail with reference to the accompanying drawings.

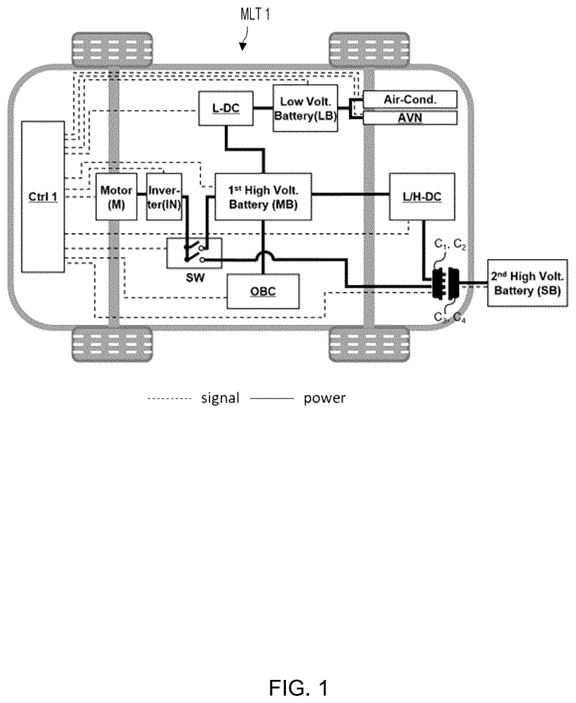

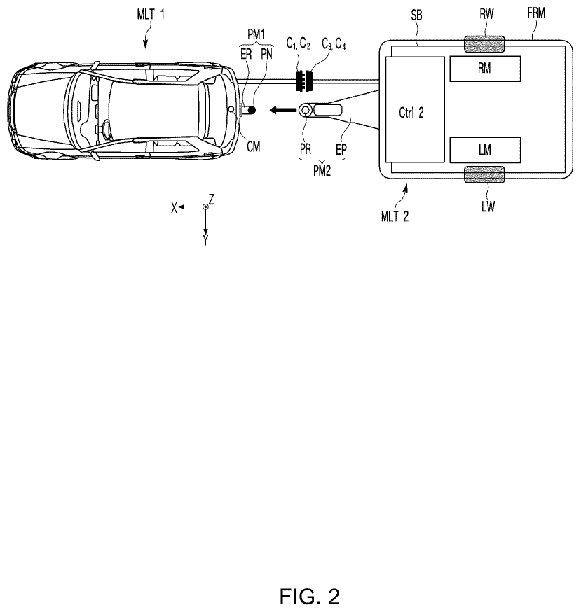

FIG. 1 conceptually shows the power system of a first mobility apparatus MLT 1 (e.g., an electric vehicle) according to an embodiment of the present disclosure. FIG. 2 shows how a second mobility apparatus MLT 2 is connected to the first mobility apparatus MLT 1 according to an embodiment of the present disclosure.

With reference to FIGS. 1 and 2, the structure of each of the first mobility apparatus MLT 1 and the second mobility apparatus MLT 2 according to an embodiment of the present disclosure is described.

As shown in FIG. 1, the first mobility apparatus MLT 1 according to an embodiment of the present disclosure is, for example, an electric vehicle, and may include a first driving motor M, an inverter IN, a first high voltage battery MB, an on-board charger OBC, a first DC/DC converter L-DC, a low voltage battery LB, an air-conditioning device Air-cond. and an audio video navigation AVN, which operate at low voltage, a second DC/DC converter L/H-DC, a switch SW, and a controller (hereinafter, referred to as a “first controller”).

The first driving motor M may provide a driving force to the wheels of a vehicle and may be an alternating current (AC) motor for example.

The inverter IN may convert a direct current power supplied to the first driving motor M into alternating current.

The first high voltage battery MB may be fixed to and installed in the body of the first mobility apparatus MLT 1, for example, under the floor of the passenger compartment.

The main function of the first high voltage battery MB may be to supply electric power to the first driving motor M and can be charged with the on-board charger OBC.

In addition, the first high voltage battery MB may be connected to the low voltage battery LB through the first direct current (DC)/DC converter L-DC to charge the low voltage battery LB.

For charging the low voltage battery LB, the first DC/DC converter L-DC may be a low-voltage DC-DC converter LDC.

The low voltage battery LB may be, for example, a 12 volts (V) or 24 V battery, and may supply electric power to electrical devices in a vehicle, such as an air-conditioning device and an AVN, which operate at low voltage.

A second high voltage battery SB shown in FIG. 1 may be installed in the second mobility apparatus MLT 2 and may be mechanically connected through a connection mechanism as described below, but is not necessarily limited thereto. For example, the second high voltage battery SB may also be removably installed in the first mobility apparatus to be mechanically connected.

The second high voltage battery SB may be additionally connected to a vehicle's power system including the first high voltage battery MB. Accordingly, the second high voltage battery SB may be detachably and electrically connected to the power system by wire (or wirelessly within possible range) in a manner that the absence of the second high voltage battery SB has no effect on the operation of the power system (power supply to electronics, a driving motor, etc. of a vehicle).

In addition, the second high voltage battery SB may be referred to as a replaceable battery, an auxiliary battery, an extended battery, or a secondary battery, but this is only to distinguish the second high voltage battery SB from the first high voltage battery MB. In other words, anything regarding the second high voltage battery SB, such as the functions, the features, its own mechanical/electrical/chemical structure or that in relationship with other objects (including the first high voltage battery MB, a host vehicle, etc.), the type of battery (including a packaging method and the type of anode material, cathode material, separator, etc.), and the charging method, is not limited by how it is called.

It may be possible for the second high voltage battery SB to communicate with a first controller Ctrl 1 of the first mobility apparatus MLT 1 or a battery management system (BMS) of the first high voltage battery MB, which is described in more detail below, by wire or wirelessly, so that various sensing information (e.g., voltage, current, temperature, etc.) related to the state of charge (SoC) and the physical/electrical/chemical state of the second high voltage battery SB may be transmitted to the first controller Ctrl 1. However, not necessarily limited thereto, the above-mentioned information related to the second high voltage battery SB may also be transmitted to the first controller Ctrl 1 through a second controller Ctrl 2 of the second mobility apparatus MLT 2, which is described in more detail below.

According to an embodiment, the high voltage battery applied to the first high voltage battery MB and the second high voltage battery SB may include, for example, a plurality of battery cells (not shown) outputting a voltage of 2.7 to 4.2 V, and a set number of battery cells may be connected in series/parallel to each other to form one module. The high voltage battery may be in the form of one or more battery modules connected to each other in series/parallel and thus packaged in one battery package to output a desired voltage, e.g., a voltage of about 400 V, about 800 V, or several kilovolts (kV).

The first high voltage battery MB and the second high voltage battery SB may each include the BMS.

The BMS may include a battery management unit (BMU), a cell monitoring unit (CMU), and a battery junction box (BJB).

The BMS may perform a cell balancing function to ensure the performance of the entire battery pack by maintaining the voltage of each cell constant, a SoC function to calculate the capacity of the entire battery system, control of battery cooling, charging, and discharge, etc.

The BMU may receive information on each cell from the CMU and fulfill the functions of the BMS based thereon.

For example, the BMU may include two micro control units (MCUs), and each MCU may have a controller area network (CAN) communication port. A CAN interface may be included for the communication with a vehicle controller, which can be said to be the upper device of the BMS, and a CAN interface may be included to collect information from the CMU, which is the lower device thereof.

The CMU may be directly attached to a battery cell and monitor voltage, current, temperature, etc. The CMU may not perform calculations related to the BMS algorithm and may only serve to monitor. One CMU may be connected to multiple battery cells, and may transmit information on each cell to the BMU through a CAN interface.

The BJB may be the mechanism for determining the pack-level of the BMS and the medium that connects the high voltage battery and drivetrain. The BJB may measure and record a battery's voltage and the current flowing in and out of the battery to accurately calculate the SoC. In addition, the BJB may perform important functions for safety, such as monitoring of insulation as well as detecting of overcurrent.

The second high voltage battery SB may be a high-voltage battery with a lower voltage than the first high voltage battery MB, and, in this case, the second DC/DC converter L/H-DC may be a DC/DC converter for voltage boosting. In contrast, the second high voltage battery SB may be a high-voltage battery with a higher voltage than the first high voltage battery MB, and, in this case, the second DC/DC converter L/H-DC may be a DC/DC converter for step-down. In addition, in this embodiment of the present disclosure, the second DC/DC converter L/H-DC may be a bidirectional converter, and it may be possible for the first high voltage battery MB and the second high voltage battery SB to charge and discharge each other.

According to an embodiment, the second DC/DC converter L/H-DC may be built into the first mobility apparatus MLT 1 in the power system. However, the present disclosure is not limited thereto. For example, in another embodiment, the second DC/DC converter L/H-DC may be provided as a separate component and may be additionally and detachably connected to the power system. In addition, the second DC/DC converter L/H-DC may be built into or detachably included in the second mobility apparatus MLT 2.

Furthermore, the second DC/DC converter L/H-DC may not be included in another embodiment. In this case, charging and discharging may not occur between the first high voltage battery MB and the second high voltage battery SB.

According to an embodiment, for the detachable and electrical connection to the power system of the second high voltage battery SB, the power system of the first mobility apparatus MLT 1 may include first and second connectors C1 and C2, and the second high voltage battery SB may include third and fourth connectors C3 and C4.

For example, the first and second connectors C1 and C2 may be in the form of one integrated connector, and the third and fourth connectors C3 and C4 may also be in the form of one integrated connector.

The first connector C1 may be connected to the second DC/DC converter L/H-DC, and the second connector C2 may be connected to the switch SW.

Although not shown, a connector for transmitting signals may be added to transmit various sensing and state information on the second high voltage battery SB to the controller.

The switch SW may be fixed to and electrically connected to the inverter IN, and may be turned on between the first high voltage battery MB and the second connector C2 to electrically connect the inverter IN and the first high voltage battery MB and/or the inverter IN and the second high voltage battery SB.

In addition, according to an embodiment, the first controller Ctrl 1 may be the highest-level vehicle controller that controls all electric devices of the first mobility apparatus MLT 1. However, the present disclosure is not necessarily limited thereto. In an example, the first controller Ctrl 1 in FIG. 1 may be a power controller subordinate to a vehicle controller.

Furthermore, as described above, the first controller Ctrl 1 according to an embodiment may include computer-readable recording media that store operating systems, logic instructions, input/output information, etc. and one or more processors that read them and perform the operation of making determinations and decisions, doing calculations, etc. to control the functions.

The second high voltage battery SB in FIG. 1 may be installed in the second mobility apparatus MLT 2 as shown in FIG. 2.

The second mobility apparatus MLT 2 may include a frame FRM, a second left wheel LW installed on the left side of the frame FRM, a second right wheel RW installed on the right side of the frame FRM, a second left driving motor LM for providing a driving force to the second left wheel LW, a second right driving motor RM for providing a driving force to the second right wheel RW, and the second controller Ctrl 2.

The second high voltage battery SB may be fixed to and installed in the second mobility apparatus MLT 2. However, the present disclosure is not necessarily limited thereto. The second high voltage battery SB may be removably installed in the second mobility apparatus MLT 2. As a result, it may be possible to replace the second high voltage battery SB mounted on the frame FRM with the SoC of being fully discharged with a new second high voltage battery SB with the SoC of being fully charged.

When the second high voltage battery SB is fixed to and installed in the second mobility apparatus MLT 2, the second mobility apparatus MLT 2 may include a charging connector for charging the second high voltage battery SB.

The frame FRM may form the exterior of the second mobility apparatus MLT 2 and may serve to accommodate other components.

The frame FRM may include a second pivot mechanism PM2 as a second connection mechanism. The second pivot mechanism PM2 may be detachably and pivotably connected to a first pivot mechanism PM1, which is a first connection mechanism fixed to the body of the first mobility apparatus MLT 1.

For example, the first pivot mechanism PM1 may include an extension rod ER extending rearwardly from the body of the first mobility apparatus MLT 1 and a pivot pin PN protruding upward from an end of the extension rod ER.

In addition, the second pivot mechanism PM2 may include a triangular-shaped extension portion EP protruding forward from the frame FRM of the second mobility apparatus MLT 2 and a pivot ring PR into which the pivot pin PN may be rotatably inserted at the end of the extension portion EP.

When the pivot pin PN is inserted into the pivot ring PR, the linear movement of the pivot pin PN may be limited, and it may only rotate in the Z-axis direction in FIG. 2. Therefore, when the second mobility apparatus MLT 2 is pivotably connected, the linear movement of the second mobility apparatus MLT 2 may be limited about the pivot connection point with respect to the first mobility apparatus MLT 1, and the second mobility apparatus MLT 2 may only rotate about the Z axis.

When driving in the forward direction, that is, in the X-axis direction, the first mobility apparatus MLT 1 and the second mobility apparatus MLT 2 may remain in a straight line even without separate control of the steering of the second mobility apparatus MLT 2.

According to an embodiment, the pivot mechanisms as the first and second connection mechanisms may be included, but it is not necessarily limited thereto. For example, the first and second connection mechanisms may be well-known mechanisms that enable non-rotational connection about the Z axis.

The rotation axis of the second left driving motor LM may be connected to the second left wheel LW so that the second left driving motor LM may supply a driving force to the second left wheel LW.

In addition, the rotation axis of the second right driving motor RM may be connected to the second right wheel RW so that the second right driving motor RM may supply a driving force to the second right wheel RW.

Because the second left wheel LW and the second right wheel RW may respectively be connected to the second left driving motor LM and the second right driving motor RM, it may be possible to drive them independently of each other.

It may be possible to drive the second left driving motor LM and the second right driving motor RM in the forward and reverse directions. When they are driven in the forward direction, the second mobility apparatus MLT 2 may travel forward, and, when they are driven in the reverse direction, it may travel backwards.

For example, the second left driving motor LM and the second right driving motor RM may each be designed as an in-wheel driving system where a driving motor is installed within a wheel, but they are not necessarily limited thereto.

In addition, in another embodiment, the second mobility apparatus MLT 2 may be driven in the matter that the left and right sides of the second mobility apparatus MLT 2 are not independent of each other and the power of one common motor is divided and transmitted to the second left wheel LW and the second right wheel RW. To this end, a differential gear may be disposed between a common second driving motor and the second left wheel LW and the second right wheel RW. Accordingly, the power of the common second driving motor may be distributed to the second left wheel LW and the second right wheel RW by the differential gear. In this case, a torque vectoring means may be added to distribute torque among the second left wheel LW and the second right wheel RW.

Referring to FIG. 2, the second controller Ctrl 2 may control the second left driving motor LM and the second right driving motor RM to allow the second mobility apparatus MLT 2 to travel forward and backward. In addition, when the steering of the second mobility apparatus MLT 2 is required, the second controller Ctrl 2 may control the torque or the number of rotations of each of the second left driving motor LM and the second right driving motor RM to change the direction in which the second mobility apparatus MLT 2 travels. That is, the driving of the second left driving motor LM and the second right driving motor RM may be separately controlled, so that it may be possible to achieve the steering of the second mobility apparatus MLT 2 without a separate steering device.

In addition, as described above, a wired or wireless communication means for transmitting information between the connectors in FIG. 1 and the first and second mobilities MLT 1 and MLT 2 may be included.

According to an embodiment, the first controller Ctrl 1 or the second controller Ctrl 2 may include a memory and a processor. Computer instructions (programs) for performing functions of a corresponding controller may be stored in the memory, and the processor may perform the above-mentioned functions by loading the instructions from the memory and executing them.

For example, the memory may include at least one of a hard disk drive (HDD), a solid-state drive (SSD), a silicon disk drive (SDD), a ROM, a RAM, a CD-ROM, a magnetic tape, a floppy disk, and an optical data storage device.

In addition, for example, the processor may include at least one of a computer, a microprocessor, a central processing unit (CPU), an ASIC, an electric circuit, and a logic circuit.

The first and second connectors C1 and C2 of the first mobility apparatus MLT 1 and the third and fourth connectors C3 and C4 of the second mobility apparatus MLT 2 may be connected to each other, and the connector for transmitting signals may be connected, so that it may be possible that the first mobility apparatus MLT 1 and the second mobility apparatus MLT 2, that is, the first controller Ctrl 1 and the second controller Ctrl 2, communicate with each other.

When the first mobility apparatus MLT 1 starts to drive forward, with the first mobility apparatus MLT 1 and the second mobility apparatus MLT 2 mechanically and electrically connected to each other, the second controller Ctrl 2 may control the second left driving motor LM and the second right driving motor RM to enable the second mobility apparatus MLT 2 to drive forward according to the signal received from the first connector C1.

Some or all of the speed, the position of the gear, the steering angle, the information on an accelerator pedal sensor (APS), and the information on a brake pedal sensor (BPS) of the first mobility apparatus MLT 1 may be transmitted to the second mobility apparatus MLT 2.

For example, the second controller Ctrl 2 of the second mobility apparatus MLT 2 may determine whether the first mobility apparatus MLT 1 is traveling forward or backward, based on some or all of the speed, the position of the gear, the information on an accelerator pedal sensor (APS), and the information on a brake pedal sensor (BPS) of the first mobility apparatus MLT 1. However, the present disclosure is not limited thereto. In an example, the second controller Ctrl 2 of the second mobility apparatus MLT 2 may receive the information on whether the first mobility apparatus MLT 1 is traveling forward or backward directly from the first controller Ctrl 1.

When the first mobility apparatus MLT 1 is traveling forward, the second controller Ctrl 2 may drive the second left driving motor LM and the second right driving motor RM in the forward direction to allow the second mobility apparatus MLT2 to drive straight ahead. Furthermore, when the first mobility apparatus MLT 1 is traveling backward, the second controller Ctrl 2 may drive the second left driving motor LM and the second right driving motor RM in the reverse direction to allow the second mobility apparatus MLT2 to drive backward.

In addition, the second controller Ctrl 2 may determine how the first mobility apparatus MLT 1 is being steered based on information on the steering angle of the first mobility apparatus MLT 1, and may steer the second mobility apparatus MLT 2 accordingly.

The second mobility apparatus MLT 2 may not include a separate steering device such as a steering wheel and a steering rack, and it may be possible to steer the second mobility apparatus MLT 2 by controlling the torque of the second left driving motor LM and the second right driving motor RM.

In an example, the second controller Ctrl 2 may calculate a driving torque for driving and a steering torque for steering of each of the second left driving motor LM and the second right driving motor RM to perform the control operation.

For example, for the steering of the second mobility apparatus MLT 2, the steering torque values of the second left driving motor LM and the second right driving motor RM according to the steering angle of the first mobility apparatus MLT 1 may be included in a lookup table or a calculation program.

When the second mobility apparatus MLT 2 drives straight ahead, the speed of the second mobility apparatus MLT 2 may be controlled to be no greater than that of the first mobility apparatus MLT 1. As a result, the pivot connection between the first mobility apparatus MLT 1 and the second mobility apparatus MLT 2 may be maintained at a pivot angle within a predetermined range. For example, when the speed of the second mobility apparatus MLT 2 driving straight ahead is controlled to be no greater than that of the first mobility apparatus MLT 1, at the pivot connection point, the pivot angle between the second mobility apparatus MLT 2 and the first mobility apparatus MLT 1 may be maintained at 0 degree, i.e., the angle where the first mobility apparatus MLT 1 and the second mobility apparatus MLT 2 are in a straight line.

When the second mobility apparatus MLT 2 is driving forward, it may be controlled to follow the first mobility apparatus MLT 1, so that the driving of multiple mobilities connected to each other may be smoothly performed.

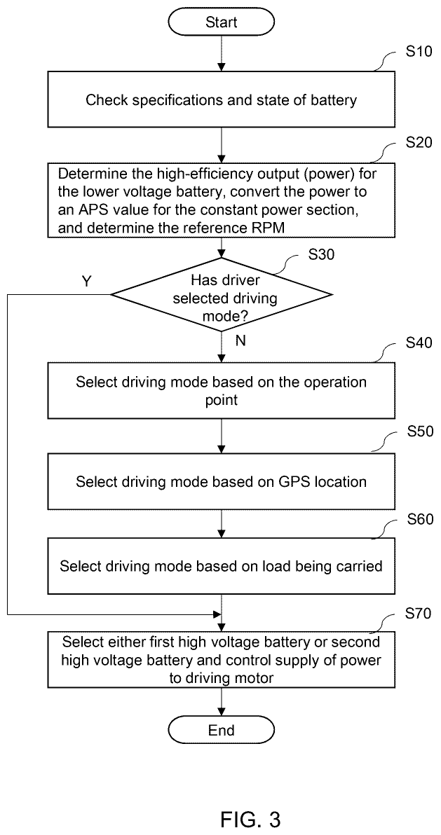

FIG. 3 is a flowchart for illustrating a control process according to an embodiment of the present disclosure.

In an embodiment, the process of controlling a battery is described as being carried out under the control of the first controller Ctrl 1. However, the present disclosure is not necessarily limited thereto.

The first controller Ctrl 1 may include a memory and a processor as described above. The memory may store a computer program for controlling the use of a battery according to this embodiment and, if necessary, various data required for the control process. The processor may execute the program stored in the memory, allowing the first controller Ctrl 1 to control the use of a battery based on the program.

Referring to FIG. 3, at a step or operation S10, the first controller Ctrl 1 may check the specifications and state of the first high voltage battery MB and/or the second high voltage battery SB.

The specifications may include at least one of a C-rate, a nominal voltage, efficiency, a maximum current, a system voltage, and a continuous output, and the battery state may include at least one of state of health (SOH), SOC, voltage, and/or temperature.

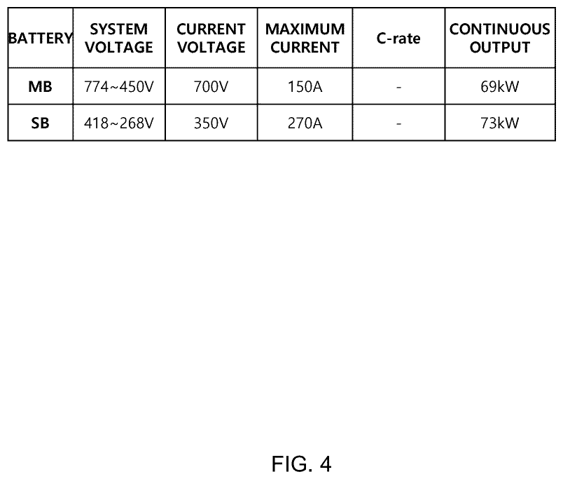

FIG. 4 shows an example of specifications of the first high voltage battery MB and the second high voltage battery SB, according to an embodiment.

In an embodiment, the first high voltage battery MB is a battery with a relatively higher voltage than the second high voltage battery SB as shown in FIG. 4. However, the present disclosure is not limited thereto.

The first controller Ctrl 1 may determine that the first high voltage battery MB is a battery with a relatively higher voltage based on the specifications of the first high voltage battery MB and the second high voltage battery SB.

In addition, at a step or operation S20, the first controller Ctrl 1 may determine a high-efficiency output, an accelerator pedal sensor (APS) conversion value, and a reference revolutions per minute (RPM) for the battery with a lower voltage among the first high voltage battery MB and the second high voltage battery SB, that is, the second high voltage battery SB.

For example, high-efficiency output data may be stored in the memory for each battery specification, and the first controller Ctrl 1 may select one of the data corresponding to the specifications of the second high voltage battery SB to determine the high-efficiency output thereof.

In addition, the first controller Ctrl 1 may convert the high-efficiency output into an APS value.

For example, a required APS value determined based on the degree to which a driver presses an accelerator pedal may be converted to a required output of the first driving motor M through an equation set in advance and stored in a memory, and the first controller Ctrl 1 may convert high-efficiency output into an APS value through the equation.

In addition, the first controller Ctrl 1 may determine a reference RPM for an RPM reference line, described in more detail below, based on a torque-RPM map for the first driving motor M.

For example, the RPM at the point where a maximum torque line and a maximum output line intersect on a torque-RPM map may be determined as a reference RPM.

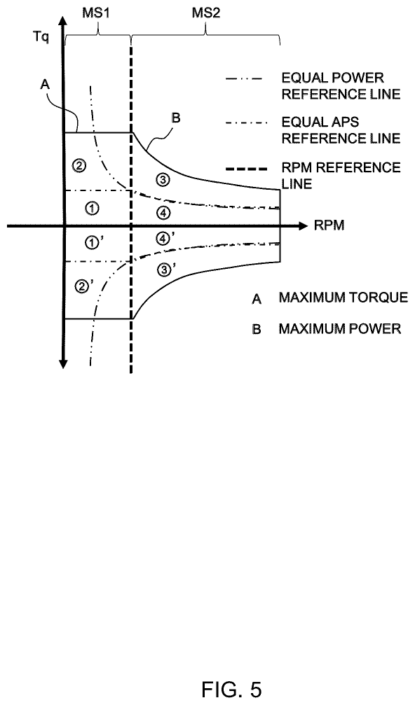

For example, on the torque-RPM map in FIG. 5, the RPM at the point where A, a maximum torque line, and B, a maximum output line, meet may be determined as a reference RPM.

In an embodiment, to determine an equal power reference line, a reference power to be described below may be used instead of the high-efficiency output data, as described in more detail below.

At a step or operation S30, the first controller Ctrl 1 may check whether a driver has selected one of multiple driving modes.

For example, a driving mode may be selected by a driver's input through an AVN screen or an input means such as a button, a jog stick, or a dial provided in the first mobility apparatus MLT 1.

For example, the multiple driving modes may include a first driving mode and a second driving mode.

The first driving mode may include a low power mode (a normal mode), and the second driving mode may include a high torque mode (a performance mode).

The low power mode may include at least one of a normal mode, a comfort mode, an eco mode, and/or a smart mode. The high torque mode may include at least one of a sports mode and/or a track mode.

The normal mode may be, for example, a general driving mode for balancing a vehicle's performance and fuel efficiency.

The comfort mode may be, for example, a mode set for driver comfort related to acceleration, braking, ride quality, etc.

The eco mode may be, for example, a mode for optimizing the fuel efficiency of a vehicle. In the eco mode, acceleration may be slow and the gear ratio of a transmission may be high, so that energy consumption may be relatively reduced. In the eco mode, an air conditioner may be controlled to automatically turn off to reduce electricity usage.

The sports mode may be, for example, a mode for maximizing the performance of a vehicle. In the sports mode, the output of the first driving motor M may be increased and the gear ratio of a transmission may be lowered, allowing the vehicle to accelerate quickly. In addition, in the sports mode, steering assistance may be increased and a suspension system may strengthen, achieve a more agile driving.

The track mode may be a mode designed for driving on a race track, and may be, for example, supported in Tesla vehicles. The track mode may change settings for stability control, traction control, regenerative braking, and a cooling system to improve performance and handling.

When it is determined that a driving mode has been selected in the step or operation S30, the process may move on to a step or operation S70 described in more detail below.

When it is not determined that a driving mode has been selected in the step or operation S30, the first controller Ctrl 1 may select a driving mode based on an operation point in a step or operation S40.

To this end, the first controller Ctrl 1 may select one of multiple driving areas based on the operation point of the first driving motor M.

FIG. 5 shows an example of multiple driving areas on a torque-RPM map, according to an embodiment.

First, as shown in FIG. 5, the multiple driving areas may include a first driving area (\textcircled{1}), a second driving area (\textcircled{2}), a third driving area (\textcircled{3}), and a fourth driving area (\textcircled{4}), which are divided by an equal power reference line, an equal APS reference line, and an RPM reference line.

The equal power reference line may be an equal power line on a torque-RPM map for high-efficiency output as described above.

In addition, the equal APS reference line may be an equal APS line for an APS value, which is the conversion value of the high-efficiency output.

Furthermore, the RPM reference line may be the reference RPM line described above. In an embodiment, the reference RPM may be the boundary between an equal torque section and an equal power section on the map in FIG. 5.

Referring to FIG. 5, the first driving area (\textcircled{1}) may correspond to the area below the RPM reference line and the equal APS reference line, the second driving area (\textcircled{2}) may correspond to the area surrounded by the equal power reference line, the equal APS reference line, and a set maximum torque line, the third driving area (\textcircled{3}) may correspond to the area above the equal power reference line, and the fourth driving area (\textcircled{4}) may correspond to the area above the RPM reference line and below the equal power reference line.

The torque area below 0 (zero) in FIG. 5 is for regenerative braking by the first driving motor M, and may likewise be divided into four driving areas by the equal power reference line, the equal APS reference line, and the RPM reference line.

In FIG. 5, the driving areas for driving by the first driving motor M and the driving areas for regenerative braking by the first driving motor M may be symmetrical with respect to the RPM axis.

In an embodiment, the first driving mode may be set as a default driving mode.

For example, when a driver does not select a specific driving mode, when the process of selecting a driving mode, described in more detail below, is not carried out, or at the beginning of driving, the first driving mode may be set as a driving mode.

In addition, when the operation point of the first driving motor M is switched from the second driving area (\textcircled{2}) to the third driving area (\textcircled{3}), the first controller Ctrl 1 may set the second driving mode as a driving mode.

For example, during driving by the first driving motor M, e.g., in a situation where torque has a positive value on the map in FIG. 5, when a driver's requested APS value corresponds to a high-speed rapid acceleration or a long ascent, the operation point may be switched from the second driving area (\textcircled{2}) to the third driving area (\textcircled{3}) and the second driving mode may be selected as a driving mode.

During regenerative braking by the first driving motor M, that is, in a situation where torque has a negative value on the map in FIG. 5, when a driver's requested brake pedal sensor (BPS) value corresponds to a steep descent on a mountain road, the operation point may be switched from the second driving area (\textcircled{2}) to the third driving area (\textcircled{3}) and the second driving mode may be selected as a driving mode.

In addition, the first controller Ctrl 1 may select the second driving mode as a driving mode when the operation point is switched from the third driving area (\textcircled{3}) to the second driving area (\textcircled{2}).

For example, during driving by the first driving motor M, when a driver's requested APS value corresponds to a steep ascent on a mountain road, the operation point may be switched from the third driving area (\textcircled{3}) to the second driving area (\textcircled{2}) and the second driving mode may be selected as a driving mode.

In addition, during regenerative braking by the first driving motor M, when a driver's requested BPS value corresponds to a high-speed rapid deceleration, the operation point may be switched from the third driving area (\textcircled{3}) to the second driving area (\textcircled{2}) and the second driving mode may be selected as a driving mode.

Furthermore, when the operation point is switched from the second driving area (\textcircled{2}) to the first driving area (\textcircled{1}), the first driving mode may be selected as a driving mode.

For example, when a required APS value corresponds to rapid acceleration on a city road or a required BPS value corresponds to rapid deceleration on a city road, the operation point may be switched from the second driving area (\textcircled{2}) to the first driving area (\textcircled{1}) and the first driving mode may be selected as a driving mode.

In addition, when the second driving area (\textcircled{2}) is maintained for a set time or longer, e.g., five seconds or longer, the first controller Ctrl 1 may select the second driving mode as a driving mode.

For example, when a required APS value corresponds to an ascent on a mountain road or a required BPS value corresponds to a descent on a mountain road, the operation point may remain in the second driving area (\textcircled{2}) and the first driving mode may be selected as a driving mode.

The operation point of the first driving motor M may be determined based on the current torque and RPM of the first driving motor M or based on a requested APS value based on a driver's pressing of an accelerator pedal.

In a step or operation S50, the first controller Ctrl 1 may select a driving mode based on a global positioning system (GPS) location.

For example, when it is determined that the first mobility apparatus MLT 1 is driving on a mountain road based on information on the location of the first mobility apparatus MLT 1 obtained through a GPS receiver, the first controller Ctrl 1 may select the second driving mode as a driving mode.

In addition, when it is determined that the first mobility apparatus MLT 1 is driving on a city road, a general road, or an expressway based on information on the location of the first mobility apparatus MLT 1, the first driving mode may be selected as a driving mode.

In a step or operation S60, the first controller Ctrl 1 may select a driving mode based on the load carried by the first mobility apparatus MLT 1.

For example, when the first mobility apparatus MLT 1 is towing the second mobility apparatus MLT 2 or another vehicle and the load being carried is equal to or greater than a set load, the first controller Ctrl 1 may select the second driving mode as a driving mode.

When a driving mode has been selected, at the step or operation S70, the first controller Ctrl 1 may select either the first high voltage battery MB or the second high voltage battery SB and control the supply of power to the first driving motor M using the selected one.

For example, when the operation point of the first driving motor M is within the second driving area (\textcircled{2}) and the first driving mode has been set as a driving mode, the first controller Ctrl 1 may select the second high voltage battery SB, which is a battery with a lower voltage among the first high voltage battery MB and the second high voltage battery SB, and may use it to supply power to the first driving motor M.

In addition, for example, when the operation point is within the second driving area (\textcircled{2}) and the second driving mode has been set as a driving mode, the first controller Ctrl 1 may select the first high voltage battery MB and use it to supply power to the first driving motor M.

When the operation point is within the fourth driving area (\textcircled{4}) and the first driving mode has been set as a driving mode, the first controller Ctrl 1 may use the first high voltage battery MB.

In addition, when the operation point is within the fourth driving area (\textcircled{4}) and the second driving mode has been set as a driving mode, the first controller Ctrl 1 may use the first high voltage battery MB.

When the operation point is within the first driving area (\textcircled{1}), the first controller Ctrl 1 may use the second high voltage battery SB regardless of a driving mode, and, when the operation point is within the third driving area (\textcircled{3}), the first controller Ctrl 1 may use the first high voltage battery MB regardless of a driving mode.

In an embodiment, the first controller Ctrl 1 may first determine that the second high voltage battery SB has been added and connected to the power system of the first mobility apparatus MLT 1.

In addition, in an embodiment, the second high voltage battery SB may be detachably connected thereto. However, the present disclosure is not limited thereto. For example, the control process according to an embodiment of the present embodiment may also be used when the second high voltage battery SB is fixed to the first mobility apparatus MLT 1.

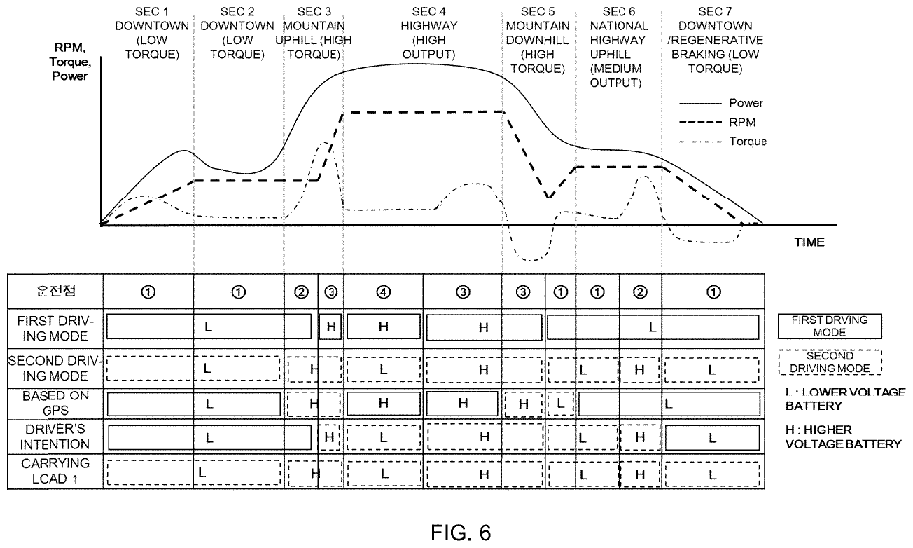

FIG. 6 illustrates a driving simulation according to an embodiment of the present disclosure.

The graph at the top of FIG. 6 shows how the RPM, torque, and power of the first driving motor M change over driving time. In addition, the diagram at the bottom of FIG. 6 shows a driving mode and a battery used for each driving section. In FIG. 6, the “low-voltage battery” corresponds to the second high voltage battery SB in the above-described embodiment, and the “high-voltage battery” corresponds to the first high voltage battery MB.

Referring to FIG. 6, the first mobility apparatus MLT 1 drives from the first driving section (SEC 1) to the seventh driving section (SEC 7). In the first driving section (SEC 1), the first mobility apparatus MLT 1 drives on a city road with low torque, and, in the second driving section (SEC 2), the first mobility apparatus MLT 1 drives on a city road with low power.

In addition, in the third driving section (SEC 3) in FIG. 6, the first mobility apparatus MLT 1 drives uphill on a mountain road with high torque, and, in the fourth driving section (SEC 4), the first mobility apparatus MLT 1 drives on an expressway with high power.

Furthermore, in the fifth driving section (SEC 5), the first mobility apparatus MLT 1 drives downhill on a mountain road with high torque regenerative braking, and, in the sixth driving section (SEC 6), the first mobility apparatus MLT 1 drives uphill on a national road with medium power.

Finally, in the seventh driving section (SEC 7), the first mobility apparatus MLT 1 drives on a city road with low torque.

In the driving situation, the operation point in the first driving section (SEC 1) and the second driving section (SEC 2) may correspond to the first driving area (\textcircled{1}). The operation point in the first half of the third driving section (SEC 3) may correspond to the second driving area (\textcircled{2}), and the operation point in the second half may correspond to the third driving area (\textcircled{3}).

In addition, the operation point in the first half of the fourth driving section (SEC 4) may correspond to the fourth driving area (\textcircled{4}), and the operation point in the second half may correspond to the third driving area (\textcircled{3}).

The operation point in the first half of the fifth driving section (SEC 5) may correspond to the third driving area (\textcircled{3}), and the operation point in the second half may correspond to the first driving area (\textcircled{1}).

In addition, the operation point in the first half of the sixth driving section (SEC 6) may correspond to the first driving area (\textcircled{1}), and, in the second half, the operation point may be switched to the second driving area (\textcircled{2}).

In the seventh driving section (SEC 7), the operation point may be switched to the first driving area (\textcircled{1}).

Here, when a driver has selected the first driving mode, as shown in FIG. 6, power may be supplied to the first driving motor M using a low-voltage battery in the first driving section (SEC 1), the second driving section (SEC 2), and the first half of the third driving section (SEC 3), and power may be supplied to the first driving motor M using a high-voltage battery in the second half of the third driving section (SEC 3) and the fourth driving section (SEC 4).

In the first half of the fifth driving section (SEC 5), the regenerative braking power generated from the first driving motor M may be controlled to charge a high-voltage battery, and, in the latter half, the first driving motor M may be controlled to supply power to the first driving motor M using a low-voltage battery.

In addition, in the sixth driving section (SEC 6), power may be supplied to the first driving motor M using a low-voltage battery.

The regenerative braking power generated in the seventh driving section (SEC 7) may be controlled to charge a low-voltage battery.

When a driver has selected the second driving mode, a low-voltage battery may be used in the first driving section (SEC 1) and the second driving section (SEC 2), and a high-voltage battery may be used in the third driving section (SEC 3).

In the first half of the fourth driving section (SEC 4), a low-voltage battery may be used, and, in the second half, a high-voltage battery may be used.

The regenerative braking power generated in the fifth driving section (SEC 5) may be controlled to charge a high-voltage battery in the first half, and may be controlled to supply power to the first driving motor M using a low-voltage battery in the latter half.

In addition, a low-voltage battery may be used in the first half of the sixth driving section (SEC 6), and a high-voltage battery may be used in the second half.

The power generated in the seventh driving section (SEC 7) may be used to charge a low-voltage battery.

Next, how a driving mode is determined based on GPS location, according to an embodiment, is described.

First, the first driving mode may be selected as a driving mode in the first driving section (SEC 1) and the second driving section (SEC 2), and a low-voltage battery may be used.

The second driving mode may be selected as a driving mode in the third driving section (SEC 3), and a high-voltage battery may be used.

The first driving mode may be selected as a driving mode in the fourth driving section (SEC 4), and a high-voltage battery may be used.

The second driving mode may be selected as a driving mode in the fifth driving section (SEC 5), and a high-voltage battery and a low-voltage battery may be used in the first half and the second half, respectively.

The second driving mode may be selected as a driving mode in the sixth driving section (SEC 6) and the seventh driving section (SEC 7), and a low-voltage battery may be used.

Next, how a driving mode is determined based on a driver's wish, i.e. an operation point, according to an embodiment, is described.

The first driving mode may be selected as a driving mode in the first driving section (SEC 1) and the second driving section (SEC 2), and a low-voltage battery may be used.

In the first half of the third driving section (SEC 3), the first driving mode may be selected as a driving mode, and a low-voltage battery may be used, while, in the second half, the second driving mode may be selected as a driving mode, and a high-voltage battery may be used.

The second driving mode may be selected as a driving mode in the fourth driving section (SEC 4), and a low-voltage battery and a high-voltage battery may be used in the first half and the second half, respectively.

The second driving mode may be selected as a driving mode in the fifth driving section (SEC 5), the regenerative braking power may be charged from a high-voltage battery in the first half thereof, and power may be supplied to the first driving motor M using a low-voltage battery in the second half thereof.

The second driving mode may be selected as a driving mode in the sixth driving section (SEC 6), and a low-voltage battery and a high-voltage battery may be used in the first half and the second half, respectively.

In addition, the first driving mode may be selected as a driving mode in the seventh driving section (SEC 7), the regenerative braking power may be charged from a low-voltage battery.

Finally, it is described how a driving mode is determined when load being carried is equal to or greater than a set load, according to an embodiment.

First, since the load being carried is equal to or greater than the set load, the second driving mode may be selected as a driving mode in all of the driving sections.

In the first driving section (SEC 1) and the second driving section (SEC 2), power may be supplied to the first driving motor M using a low-voltage battery, and, in the third driving section (SEC 3), a high-voltage battery may be used.

In the first half of the fourth driving section (SEC 4), a low-voltage battery may be used, and, in the second half thereof, a high-voltage battery may be used.

In addition, in the first half of the fifth driving section (SEC 5), the regenerative braking power may be charged from a high-voltage battery, and, in the second half, a low-voltage battery may be used to supply power to the first driving motor M.

In the sixth driving section (SEC 6), a low-voltage battery and a high-voltage battery may be used in the first half and the second half, respectively.

In addition, the regenerative braking power generated in the seventh driving section (SEC 7) may be charged from a low-voltage battery.

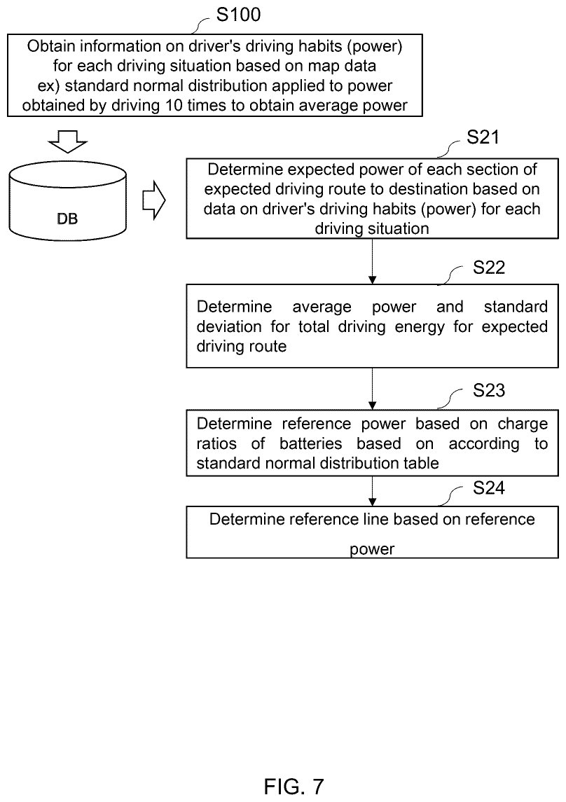

FIG. 7 illustrates the process of determining an equal power reference line for determining a battery to be used.

In the above-described embodiment, output power may be determined based on data on high-efficiency power of a battery with a relatively lower voltage among the first high voltage battery and the second high voltage battery to determine the equal power reference line. In another embodiment, described below, a reference power may be determined in another way.

First, referring to FIG. 7, in a step or operation S100, the first controller Ctrl 1 may obtain information on a driver's driving habits for each driving situation based on map data and store it in a database.

The map data may be, for example, for the navigation function of an AVN, but is not necessarily limited thereto.

The driving situation may be based on the type of road in the map data, for example.

For example, based on the map data, the driving situations may be classified according to section such as a city road section, a mountain uphill section, a mountain downhill section, an expressway section, a national road section, and a regenerative braking section.

The city road section may include a road section defined as a city road in the road information on the map data, the mountain section may include a road section defined as a mountain road in the road information on the map data, and the expressway section and the national road section may include road sections defined as an expressway and a national road, respectively, in the road information on the map data.

In addition, regenerative braking may be performed based on regenerative braking conditions set during driving, and the section may be defined as a regenerative braking section.

For example, the regenerative braking conditions may include deceleration, a driving distance or time to reach a target speed, a battery's SoC, etc., but are not necessarily limited thereto.

For example, data on a driver's driving habits for each driving situation may be obtained through learning.

To this end, while a host vehicle is driving a set driving distance in each driving situation, data on power supplied to the driving motor M based on a driver's required power, i.e., discharge power of a battery (MB or SB), may be obtained in real time to determine the average discharge power of the driving of the driving distance, which may be repeated a set number of times to obtain data on the average discharge power.

Then, a standard normal distribution may be applied to the data on the obtained average discharge power to determine an average value based on probability weighting. The average value may then be determined as the average discharge power for the corresponding driving situation.

In an example, the driver's required power may be determined based on, for example, an accelerator position sensor (APS) signal.

In addition, in the same way, while a host vehicle is driving a set driving distance in each driving situation, data on regenerative braking power based on a driver's required deceleration, i.e. regenerative braking charging power to a battery, may be obtained in real time to determine the average charging power of the driving of the driving distance, which may be repeated a set number of times to obtain data on the average charging power.

Then, likewise, a standard normal distribution may be applied to the data on the obtained average charging power, to determine an average value based on probability weighting. The average value may then be determined as the average charging power for the corresponding driving situation.

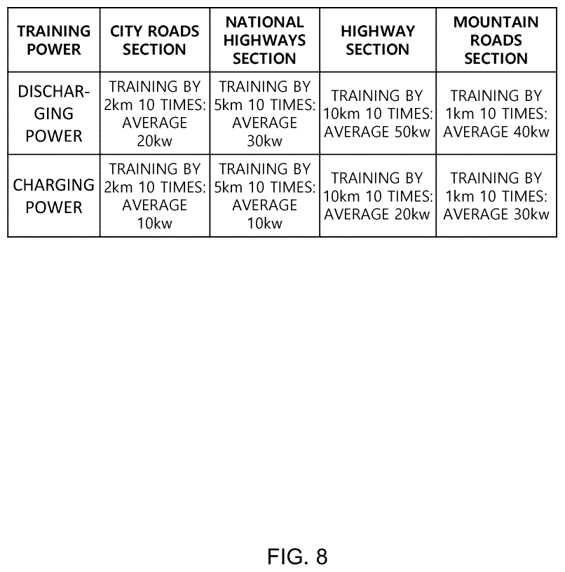

FIG. 8 shows an example of average powers obtained through learning in each driving situation, according to an embodiment.

First, a standard normal distribution may be applied to discharge power obtained by driving 2 kilometers (km) each 10 times in a city road section to obtain an average discharge power of 20 kilowatts (kW).

In addition, a standard normal distribution may be applied to charging power obtained by driving 2 km each 10 times in a city road section to obtain an average charging power of 10 kW.

In a national road section, a standard normal distribution may be applied to discharge power obtained by driving 5 km each 10 times to obtain an average discharge power of 30 kW. In addition, a standard normal distribution may be applied to charging power obtained by driving 5 km each 10 times to obtain an average charging power of 10 kW.

In an expressway section, a standard normal distribution may be applied to discharge power obtained by driving 10 km each 10 times to obtain an average discharge power of 50 kW. In addition, a standard normal distribution may be applied to charging power obtained by driving 10 km each 10 times to obtain an average charging power of 20 kW.

In a mountain road section, a standard normal distribution may be applied to discharge power obtained by driving 1 km each 10 times to obtain an average discharge power of 40 kW. In addition, a standard normal distribution may be applied to charging power obtained by driving 1 km each 10 times to obtain an average charging power of 30 kW.

According to an embodiment, it may be possible to continuously update data on driving habits for each driving situation by continuously accumulating data for each situation.

Referring back to FIG. 7, in a step or operation S21, the first controller Ctrl 1 may determine one or more sections of an expected driving route based on data on driving habits for each driving situation and determine an expected power of each section.

For example, the expected driving route may be determined based on a route from the current location to a destination as the destination is entered into a navigation system of an AVN.

For example, for the expected driving route, one or more sections may be determined based on a driving situation based on a city road section, a mountain road section, an expressway section, a national road section, a regenerative braking section, etc.

In addition, the first controller Ctrl 1 may determine an expected power, i.e., a charging or discharge power, of each section based on the data on driving habits in each driving situation.

In a step or operation S22, the first controller Ctrl 1 may determine an average power and a standard deviation for a corresponding expected driving route.

To this end, the first controller Ctrl 1 may obtain a driving ratio of each section of the expected driving route through Equation 1.

Driving ratio of each section=driving time for a corresponding section/total driving time. [Equation 1]

In Equation 1, the total driving time means the total driving time for an expected driving route.

Next, an average power for the expected driving route may be obtained through Equation 2.

Average discharge power=Σ(expected discharge power of each section*driving ratio of each section).

Average charging power=Σ(expected charging power of each section*driving ratio of each section). [Equation 2]

In addition, through Equation 3, the standard deviation for the expected driving route may be obtained.

Standard deviation for discharge power²=Σ{(expected discharge power of each section-average discharge power)²*driving ratio of each section}.

Standard deviation for charging power²=Σ{(expected charging power of each section-average charging power)²*driving ratio of each section}. [Equation 3]

In a step or operation S23, the first controller Ctrl 1 may determine a reference power based on the charge ratio of the first high voltage battery (hereinafter, referred to as a “high-voltage battery”) and the second high voltage battery (hereinafter, referred to as a “low-voltage battery”).

Since the first high voltage battery MB may have a higher voltage than the second high voltage battery SB according to the above-described embodiment, for convenience of description, the first high voltage battery MB is referred to as a high-voltage battery, and the second high voltage battery SB is referred to as a low-voltage battery.

First, the charge ratio of each battery may be determined by dividing the charge of each battery by the total charge of the high-voltage battery and the low-voltage battery.

Next, a Z-score may be determined from a standard normal distribution table by using the charge ratio of each battery as a target probability (target usage level) value, and a reference parameter K may be determined therefrom.

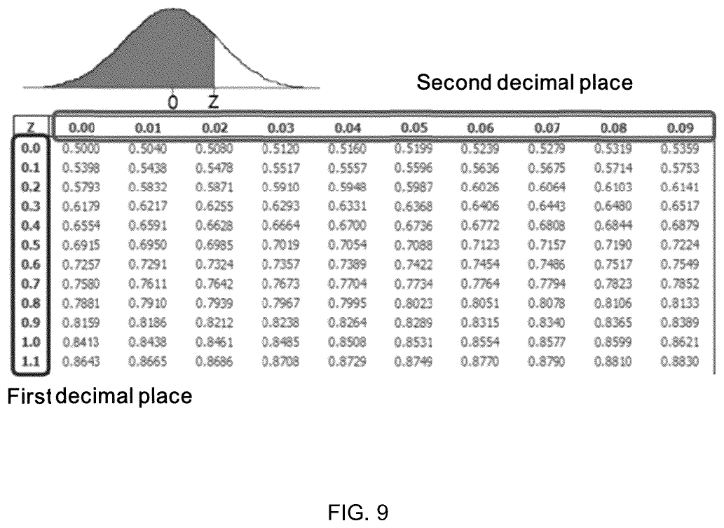

For example, assuming that the charge ratio of the high-voltage battery to the low-voltage battery is 2:1, the target probability (target usage level) value for the high-voltage battery may be 0.6667, and the corresponding Z-score may be determined to be 0.43 from the table in FIG. 9.

In this case, the reference parameter K may be determined to be 0.43.

In addition, a reference power during being discharged may be obtained through Equation 4.

Charge ratio of high-voltage battery>charge ratio of low-voltage battery: reference power=average discharge power−K*standard deviation for discharge power.

Charge ratio of high-voltage battery<charge ratio of low-voltage battery: reference power=average discharge power+K*standard deviation for discharge power. [Equation 4]

In addition, a reference power during charging may be obtained through Equation 5.

Charge ratio of high-voltage battery>charge ratio of low-voltage battery: reference power=average charging power+K*standard deviation for charging power.

Charge ratio of high-voltage battery<charge ratio of low-voltage battery: reference power=average charging power−K*standard deviation for charging power. [Equation 5]

When a reference power has been determined, the first controller Ctrl 1 may determine an equal power reference line based on the reference power in a step or operation S24.

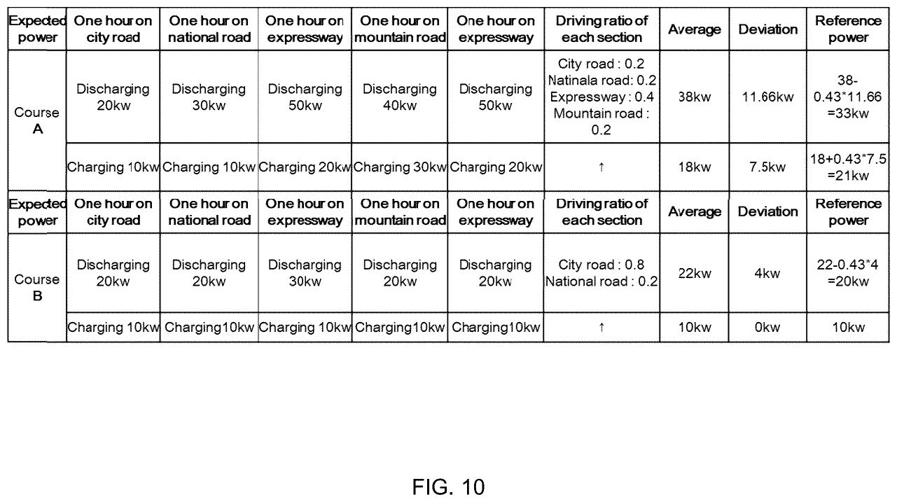

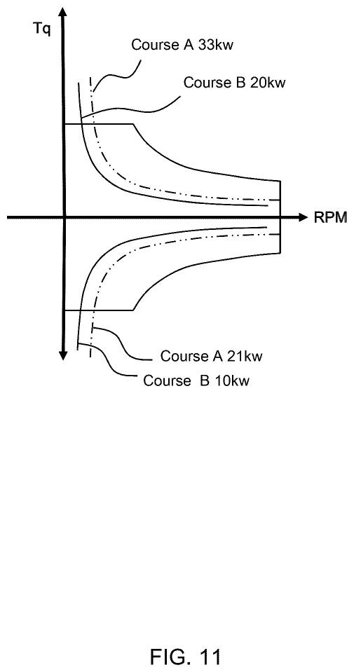

FIGS. 10 and 11 show the results of applying an embodiment of the present disclosure to a virtual expected driving route.

First, Course A has an expected driving route including sections of one hour on a city road, one hour on a national road, one hour on an expressway, one hour on a mountain road, and one hour on an expressway.

Expected powers determined based on data on driving habits in each section of Course A may be as follows: a discharge power of 20 kW and a charging power of 10 kW in the section of one hour on a city road, a discharge power of 30 kW and a charging power of 10 kW in the section of one hour on a national road, a discharge power of 50 kW and a charging power of 20 kW in the section of one hour on an expressway, a discharge power of 40 kW and a charging power of 30 kW in the section of one hour on a mountain road, and a discharge power of 50 kW and a charging power of 20 kW in another section of one hour on an expressway.

The driving ratio of each section of Course A as described above may be calculated as 0.2 for the city road section, 0.2 for the national road section, 0.4 for the expressway section, 0.2 for the mountain road section, etc.

In addition, in the case of Course A, the average discharge power may be 38 kW, and the standard deviation of the discharge power may be 11.66 kW, the average charging power may be 18 kW, and the standard deviation of the charging power may be 7.5 kW.

Assuming that the charge ratio of the high-voltage battery to the low-voltage battery is 2:1, when reference powers are determined for Course A through Equations 4 and 5, the reference power during being discharged may be determined to be 33 kW, and the reference power during being charged may be determined to be 21 kW.

The reference powers for Course B in FIG. 10 may be determined to be 20 kW during being discharged and 10 kW during being charged.

FIG. 11 shows equal power reference lines based on the reference powers for Courses A and B, and, as shown therein, the reference line of Course A may be to the right of the reference line of Course B. Since a reference line may vary depending on course as described above, the usage ratio or usage probability (usage level) of the high-voltage and low-voltage batteries may vary depending on course, thereby preventing the biased use of either battery.

Example embodiments of the present disclosure have been shown and described, but the present disclosure is not limited to the specific embodiments described above. Various modifications can be made to the present disclosure within the gist of the present disclosure claimed in the appended claims by a person having ordinary skill in the art, and such modifications should not be understood separately from the technology of the present disclosure.

What is claimed is:

1. A method of controlling batteries for a vehicle, the vehicle including a driving motor for providing a driving force to a wheel of the vehicle, the method comprising:
selecting, by a controller, a battery among a first battery and a second battery based on a plurality of driving areas and an operation point for the driving motor, and
controlling, by the controller, use of the selected battery to supply power to the driving motor or receive power regenerated by the driving motor,
wherein selecting the battery includes classifying the plurality of driving areas according to a reference power.

2. The method of claim 1, wherein classifying the plurality of driving areas includes classifying the plurality of driving areas according to an equal power reference line of the reference power based on a torque-rotations per minute (RPM) map of the driving motor.

3. The method of claim 2, wherein classifying the plurality of driving areas further includes determining the reference power based on respective usage levels of the first battery and the second battery, the respective usage levels determined based on respective charge levels of the first battery and the second battery.

4. The method of claim 3, wherein determining the reference power includes determining the reference power based on an expected driving route and the respective usage levels of the first battery and the second battery.

5. The method of claim 4, wherein determining the reference power based on the expected driving route and the respective usage levels of the first battery and the second battery includes:
determining one or more sections of the expected driving route based on driving situations;
determining an expected power of each of the one or more sections;
determining an average power and a standard deviation for the expected driving route; and
determining the reference power based on the respective usage levels using the average power and the standard deviation.

6. The method of claim 5, wherein determining the reference power based on the respective usage levels using the average power and the standard deviation includes determining a target usage level value, the target usage level value determined based on a charge ratio of the first battery and a charge ratio of the second battery.

7. The method of claim 6, wherein determining the reference power based on the respective usage levels using the average power and the standard deviation further includes:
determining a Z-score from a standard normal distribution table based on the target usage level value to determine a reference parameter; and
determining the reference power based on the average power, the standard deviation, and the reference parameter.

8. The method of claim 7, wherein the first battery has a higher voltage than the second battery, and determining the reference power based on the average power, the standard deviation, and the reference parameter includes at least one of:
determining the reference power for discharge by subtracting a product of the reference parameter and the standard deviation from the average power when the charge ratio of the first battery is greater than the charge ratio of the second battery;
determining the reference power for the discharging by adding a product of the reference parameter and the standard deviation to the average power when the charge ratio of the first battery is less than the charge ratio of the second battery;
determining the reference power for charging by adding a product of the reference parameter and the standard deviation to the average power when the charge ratio of the first battery is greater than the charge ratio of the second battery; or
determining the reference power for the charging by subtracting a product of the reference parameter and the standard deviation from the average power when the charge ratio of the first battery is less than the charge ratio of the second battery.

9. The method of claim 5, wherein determining the average power and the standard deviation includes:
determining a driving ratio of each of the one or more sections for the expected driving route; and
determining the average power and the standard deviation based on the expected power and the driving ratio of each of the one or more sections.

10. The method of claim 5, wherein determining the expected power of each of the one or more sections includes determining the expected power based on data on driving habits of a driver of the vehicle.

11. A vehicle controller configured to control batteries for a vehicle, the vehicle including a driving motor for providing a driving force to a wheel of the vehicle, the vehicle controller comprising:
a non-transitory memory storing instructions; and
one or more processors configured to execute the instructions,
wherein the instructions, when executed by the one or more processors, cause the one or more processors to:
select a battery among a first battery and a second battery based on a plurality of driving areas and an operation point for the driving motor, and
control use of the selected battery to supply power to the driving motor or receive power regenerated by the driving motor, and
wherein the one or more processors are configured to select the battery based on classifying the plurality of driving areas according to a reference power.

12. The vehicle controller of claim 11, wherein the instructions, when executed by the one or more processors, cause the one or more processors to classify the plurality of driving areas according to an equal power reference line of the reference power based on a torque-revolutions per minute (RPM) map of the driving motor.

13. The vehicle controller of claim 12, wherein the instructions, when executed by the one or more processors, cause the one or more processors to determine the reference power based on respective usage levels of the first battery and the second battery, the respective usage levels determined based on respective charge levels of the first battery and the second battery.

14. The vehicle controller of claim 13, wherein the instructions, when executed by the one or more processors, cause the one or more processors to determine the reference power based on an expected driving route and the respective usage levels of the first battery and the second battery.

15. The vehicle controller of claim 14, wherein the instructions, when executed by the one or more processors, cause the one or more processors to:
determine one or more sections of the expected driving route based on driving situations;
determine an expected power of each of the one or more sections, while determining an average power and a standard deviation for the expected driving route; and
determine the reference power based on the respective usage levels using the average power and the standard deviation.

16. The vehicle controller of claim 15, wherein the instructions, when executed by the one or more processors, cause the one or more processors to determine a target usage level value based on a charge ratio of the first battery and a charge ratio of the second battery.

17. The vehicle controller of claim 16, wherein the instructions, when executed by the one or more processors, cause the one or more processors to:
determine a Z-score from a standard normal distribution table based on the target usage level value to determine a reference parameter; and
determine the reference power based on the average power, the standard deviation, and the reference parameter.

18. The vehicle controller of claim 17, wherein the first battery has a higher voltage than the second battery, and wherein the instructions, when executed by the one or more processors, cause the one or more processors to perform at least one of:
determine the reference power for discharging by subtracting a product of the reference parameter and the standard deviation from the average power when the charge ratio of the first battery is greater than the charge ratio of the second battery;
determine the reference power for the discharging by adding a product of the reference parameter and the standard deviation to the average power when the charge ratio of the first battery is less than the charge ratio of the second battery;
determine the reference power for charging by adding a product of the reference parameter and the standard deviation to the average power when the charge ratio of the first battery is greater than the charge ratio of the second battery; or
determine the reference power for the charging by subtracting a product of the reference parameter and the standard deviation from the average power when the charge ratio of the first battery is less than the charge ratio of the second battery.

19. The vehicle controller of claim 15, wherein the instructions, when executed by the one or more processors, cause the one or more processors to:
determine a driving ratio of each of the one or more sections for the expected driving route; and
determine the average power and the standard deviation based on the expected power and the driving ratio of each of the one or more sections.

20. The vehicle controller of claim 15, wherein the instructions, when executed by the one or more processors, cause the one or more processors to determine the expected power based on data on driving habits of a driver of the vehicle.
